(19) United States
(12) Patent Application Publication
(10) Pub. No.: US 2002/0138244 A1
(43) Pub. Date: Sep. 26, 2002

(54) Simulator independent object code HDL simulation using PLI

(76) Inventor: Steven J. Meyer, Mill Valley, CA (US)

Correspondence Address: Patterson, Thuente, Skaar & Christensen, P.A., 4800 IDS Center, 80 South 8th Street, Minneapolis, MN, 55402-2100, US

(21) Appl. No.: 10/076,045

(22) Filed: Feb. 12, 2002

Related U.S. Application Data
(63) Continuation of application No. 09/668,109, filed on Sep. 22, 2000.
(60) Provisional application No. 60/156,732, filed on Sep. 30, 1999.

(51) Int. Cl. G06F 17/50

(52) U.S. Cl. 703/14

(57) ABSTRACT

An HDL circuit conversion and simulation method is described. One or more HDL source modules are converted to simulation program libraries and simulated. The simulation system and method compiles HDL models into linkable libraries. Resulting libraries include calls to the HDL's PLI so that the libraries along with HDL source can be simulated using any simulator of the HDL. The host simulator provides scheduling and system operations that are requested by the linkable simulation program libraries produced by the simulation system here disclosed. The system and method is called an HDL simulator independent PLI based model compiler. The simulation system allows utilization of HDL simulator advances without changing linkable libraries.

### CLAIM TO PRIORITY

The present application claims priority to earlier filed continuation application No. 09/668,109, filed Sept. 22, 2000, entitled “Simulator Independent Object Code HDL Simulation Using PLI” which claims priority to United States Provisional Patent Application No. 60/156,732, filed Sept. 30, 1999, and entitled “System and Method for Translating and Verifying Electronic Hardware Models.” The identified provisional and utility patent applications are hereby incorporated by reference.

### BACKGROUND OF THE INVENTION

1. Field of Invention

This invention generally relates to a simulation method and apparatus, and, in particular, for converting and simulating electronic circuits coded in Hardware Description Languages (HDL). The method and apparatus takes as input one or a plurality of HDL modules and creates one or a plurality of binary machine code linkable libraries that are linked with an HDL simulator to verify an electronic circuit. The system and method is a new type of model compiler that utilizes a specialized software application programming interface (API) called a programming language interface (PLI). The system and method is used in verifying logic and timing of semiconductor integrated circuits in the field of electronic computer aided design (ECAD).

2. Prior Art

Because of advances in integrated circuit (IC) technology, it is now possible to design an entire system on one chip (SoC). This advance creates a need for the ability to combine many subcircuits into one HDL system model that can be verified using simulation. Although HDLs for digital circuits are most common analog and mixed signal have been defined. Additionally, HDLs for some circuit aspects not yet discovered may be defined in the future.

Because of the high complexity of modem electronic systems, there is economic advantage to have the ability for enterprises to specialize in designing one type of subcircuit such as DVD decoders. The final SoC system then comprises HDL descriptions from many sources. Such subcircuit or subsystem models are called soft IP (intellectual property) because they are defined by an HDL program and because the model is transistor type independent. For example, a soft IP model can be fabricated using CMOS technology for low power applications and using gallium arsenide for high speed applications. Soft IP is contrasted with hard IP in which subcircuits are defined as wafer fabrication mask patterns.

The current electronic system design steps are:

1. Determine system specifications

2. Verify correct architectural function

3. Convert specifications into HDL definition

4. Verify correct system logic and timing

5. Convert HDL to physical layout (called physical design)

Steps 3 and 4 are called logic design. The system and method here described accomplishes step 4 above. Logic design uses the hardware description language (HDL) to represent circuit information. The conversion from specification to logic gate level HDL model can be direct or, alternatively, a procedural HDL model (sometimes called RTL or behavioral model) can first be created and the procedural HDL code can then be synthesized into a gate level HDL model. Using the logic design HDL description created in step 3, the HDL description is verified in step 4 using a computer program called an HDL simulator. Although, sometimes other verification methods such as formal verification are used, other methods are used in conjunction with HDL simulation.

I. Current HDLs

Currently, the most commonly used HDL is called Verilog. Another HDL is called VHDL. A number of new HDLs are under development such as Superlog and SDL. Many simulators are available for simulating correct logic and timing function of Verilog HDL models. Steps 3 and 4, described above, used in modern circuit design replace the original design method that required physical prototyping by building PCBs using a technique called bread boarding. HDLs are now routinely standardized by U.S. or international standard organizations such as IEEE or ISO. The Verilog HDL is standardized as IEEE standard P1364 and the VHDL HDL is standardized as IEEE standard P1076. HDL standardization allows many different circuit design tools from multiple vendors to be used to verify a given HDL system model.

II. Module as Basic HDL Construct

HDLs describe circuits in modular form. For Verilog, each module is defined between a pair of reserved words “module” and “endmodule” as shown in FIG. 1. A plurality of modules may be provided in sequence and modules may be arranged in hierarchical structure. When a module is nested in another module, the nested module is called an instance. A system model contains the combination of the plurality of source files containing module definitions plus any HDL library files containing module definitions. Library module definitions are only included in the complete HDL system model if they are needed to resolve an unresolved instantiation.

Ill. HDL Module Constructs

HDL modules contain the following language constructs (see FIG. 1—line number references used below all refer to FIG. 1):

1. PORTS: Port types are input, output, or inout. Inout ports propagate signals in both directions (lines 6-10).

2. VARIABLES: Variables are local to modules and are register variables that model registers and programming language variables or wires that behave like circuit wires, i.e., have fan-in, fan-out, and float to high impedance if not actively driven (lines 13-17).

3. PARAMETERS: Parameters are named constants (line 20).

4. INSTANCE CONSTRUCTS (instantiations): Since HDL system descriptions are hierarchical instances, HDL descriptions of systems are usually coded top down. Top level modules normally provide system testing environment (called test scaffolding) containing one or a plurality of instantiations of a system model and HDL code to provide system input stimuli and check system output. Inside a module, the various subcomponents of a system are instantiated. For complex systems, there many be many instances of a given subsystem. Each of which is separately instantiated. For SoCs, all instances are fabricated onto one chip (lines 23-24).

5. GATE AND CONTINUOUS ASSIGN CONSTRUCTS: Procedural constructs are used for high level modeling and are easy for people to code but are too far from actual hardware devices to be input to physical design. HDLs also allow gates and switches that correspond to actual IC devices to be modeled. Gates and instances are declarative. Therefore, unlike procedural constructs, order within a module definition has no effect on what is modeled. Gates may have delays. But even for gates without delays, gate evaluation must be scheduled using event driven semantics for accurate timing level HDL verification.

Continuous assignments are the same as gates except the right hand side expression for continuous assignments is an arbitrary expression. Many HDLs allow user defined gates that are defined using tables. In Verilog such gates are called UDPs (lines 27-29).

6. PROCEDURAL CONSTRUCTS: Procedural constructs model behavior using parallel HDL “program” execution. Some procedural constructs such as delay controls, always blocks, and fork-join require scheduling. These are called scheduled procedural constructs. Some constructs just compute new values. They are called timing free procedural constructs. Usually a block of timing free procedural code is preceded by and triggered by scheduled procedural code that synchronizes behavioral model execution. HDLs also allow definition of reused groups of statements as tasks or functions. In Verilog, tasks contain both scheduled and timing free procedural constructs. Functions only contain timing free procedural constructs (lines 32-46).

7. SYSTEM TASK AND FUNCTION CONSTRUCTS: These operations provide testing and debugging HDL features. For example, the $display system task allows printing from within HDL models. $time is a system function returning current simulation time. $readmem is a complex system task that reads from a computer data file and fills an HDL memory. System constructs correspond in HDL modeling to operating system services on computers (line 46).

8. USER CODED PLI CONSTRUCTS: Since a complex SoC system contains many different subsystems from many different sources, system HDL models typically contain many levels of modeling from switches and gates that are directly fabricated, through behavior and RTL models that are synthesized to gates, to abstract computer program models. Such high level computer program models are written using an HDL's standardized application programming interface (API) called the programming language interface or PLI. The services provided by the PLI for most modern HDL's allow access to and invocation of all HDL constructs (line 51).

9. INPUT TO OUTPUT PATH DELAY CONSTRUCTS (specify block): In addition to distributed gate delays, HDLs allow coding input to output path delays. In Verilog, the construct is called the specify block that contains delay paths and timing checks. Delay paths require scheduling of values assigned to circuit outputs by delaying procedural (behavioral) or RTL output changes until the path delay has elapsed. Another type of constant parameter is called a specparam (lines 55-61). IV. HDL Simulation Methods

Recent advances in HDL simulation have resulted in many different specialized simulators that all work from a common and standardized HDL system model. Some types of simulation are:

1. INTERPRETED SIMULATION: This type of simulation is good for debugging and accurate timing validation but slower than some other methods.

2. COMPILED SIMULATION: This type of simulation is a faster simulation so that more test patterns and system operations are simulated in a given period of time, but compiled simulation sacrifices debugging access to model details.

3. CYCLE BASED SIMULATION: Similar to compiled simulation, cycle based simulation allows very fast simulation for regularly clocked systems such as microprocessors allowing actual computer instructions to be validated by simulation, but intra-cycle timing verification is inaccurate.

4. HARDWARE ACCELERATOR BASED SIMULATION: This type of simulation is a simulation algorithm that is implemented in computer hardware allowing for very fast simulation. However, hardware accelerator-based simulation is usually limited to gate models and the time to elaborate and load an HDL system description before simulation starts is long.

5. SYMBOLIC SIMULATION: Symbolic simulation is currently being researched.

V. Modern Computer Program Linking

Originally an executable binary computer program was constructed by linking together a plurality of compiled computer language files into one non-relocatable binary executable program. However, modem software development tools allow a number of different methods for constructing a binary executable program. These methods include:

1. PARTIAL LINKING: Partial linking provides for a plurality of object files to be partially linked into a new object file. First, each computer language source is compiled into a relocatable object file called an .o file. The plurality of .o files are partially linked to make one new relocatable .o object file. The new partially linked relocatable object file is then linked with other object files to construct a binary executable.

2. DYNAMIC LIBRARIES: Dynamic libraries contain elements referenced symbolically in object files so that a dynamic library may be changed but still allow linking with previously linked object files. This allows libraries and programs to be developed and changed independently. Dynamic libraries are often called .so files or DLLs since they contain symbolic references. A binary executable program is created by linking any or all of .o object files, partially linked .o object files and dynamic library .so files.

3. DYNAMIC LINKING: In dynamic linking, the executing program loads and links dynamic libraries while running using a predefined Operating System API that provides routines for loading and linking (and unloading) program objects (routines and data structures).

This allows a program to start executing, decide what dynamic libraries need to be loaded, and then make calls to the dynamic linking API to only load libraries needed for the particular run. The routines in the API typically start with a dl prefix: dlopen, dlclose, dlsym, etc. One or more user source files must be compiled and linked using special dynamic library commands to prepare them for later dynamic linking. In HDL simulation, user PLI programs are typically dynamically loaded.

VI. PLI Description

HDL PLIs allow linking programs written in common programming languages such as C to be compiled into one or a plurality of object libraries that are then linked with an elaborated HDL system model just before simulation begins. Any programming language code can be included in the PLI program. HDL definitions define names, functions, and actual parameters of program language routines that user PLI programs call to interact with HDL simulator.

HDL PLIs have been used in other inventions in the circuit simulation area. See for example U.S. Pat. No. 5,774,380, “State Capture/Reuse for Verilog Simulation of High Gate Count ASIC” that uses the PLI for accessing and re-using circuit simulation state.

For example, in Verilog the routine vpi_register_cb is used to register a user program function (called a call back) that is called by an HDL simulator when the specified event happens such as change of a wire. It takes a PLI defined record called a cb_data structure as its one argument. HDL PLIs are very similar to other APIs that, for example, allow middle ware to be used with computer operating systems and electronic simulators.

HDL PLIs define at least five basic routine classes:

1. ROUTINES THAT REGISTER CALL BACKS: Call backs allow the HDL simulator to call a user program routine when a particular event happens such as: a particular system task is executed ($pli_memory_model in FIG. 1), a net or variable changes (for example to monitor every time an output of a particular instance changes), or a simulation related event occurs (for example when simulation time reaches 1000).

2. ROUTINES THAT ACCESS VALUES: HDL system model values are read using value access routines. In Verilog the routine is called vpi_get_value. It reads the value of any object that has a value. For example, the value that a system task recently returned (if task is not active) or the value that will be returned (if task is active) can be read.

3. ROUTINES THAT ASSIGN VALUES: HDL system model values are written using value setting routines. In Verilog the routine is called vpi_put_value. Values are normally written to nets and regs after a given delay has elapsed when the delay type argument is properly set and a delay record is passed as another argument.

4. ROUTINES THAT ALLOW ACCESS TO HDL CONSTRUCTS: HDL source construct access routines (see “Background of the Invention” section III) allow determination of exact details of HDL circuit description. In Verilog the one-to-one HDL construct access routine is named vpi_handle and the one-to-many access routine is named vpi_iterate.

For example, vpi_iterate is used to access all ports for a given instance. vpi_handle is used to access instance connections to a port called vpiHighConn or port connections inside a module called vpiLowConn. Most HDLs allow complete HDL source reconstruction using PLI access routines.

5. ROUTINES THAT ALLOW DELAY READING AND WRITING: HDL delays are read and written using the PLI delay routines. In Verilog, routine vpi_get_delays is used to read delays and vpi_put_delays is used to set delays. PLI delay reading and writing is normally used before simulation begins.

In operation, an HDL simulator is informed that one or a plurality of user PLI programs must be loaded and executed with a predefined table of call back routines that the simulator reads when it begins running if the table has been linked into the simulator binary. If no PLI routines exist, the predefined table is empty. If many different PLI programs are used during an HDL simulation there will normally be one start up call back routine in the predefined table for each PLI application (see “Background of the Invention” section VI, item 3).

The Verilog PLI is defined more completely in “IEEE Std 1364-1995 Verilog Hardware Description Language Reference Manual.” TEEE Standards Board. chap. 17-23, IEEE: New York, 1996, which is hereby incorporated by reference.

VII. System on a Chip Design

SoC systems normally consist of a plurality of subsystems designed by different enterprises. In older electronic systems, subsystem components consisted of different physical ICs that could be fabricated and tested independently and then assembled into final electronic systems. SoC systems consist only of HDL descriptions that are used as input to physical design (design step 5 above). Although subsystems can be separately verified by HDL simulation, once an SoC IC is fabricated, subsystems lose identity and only the entire fabricated SoC ICs are tested.

The ability to fabricate entire systems on one IC has led to specialization. One type of specialized subsystem design enterprise is called a soft IP (intellectual property) vendor. Such enterprises design subsystems as HDL models of function and timing. For example, IP vendors may specialize in DVD decoders or memory subsystems. Soft IP models coded as HDL circuit descriptions are then licensed to system design enterprises. Although, the most common need for the system and method of the present invention is for third party soft IP vendors to protect their technology, system vendors may design systems by decomposing systems into subsystems each of which is designed separately and converted into a soft IP model. Here, there is no need to protect IP because it was developed by system vendor, but the design approach assists in the parallel development of subsystems.

Because of electronic design specialization, there is a need to combine into one system simulation a plurality of subsystems HDL models created by different enterprises. From the system vendor's perspective, there is a need for a well-defined interface so that problems are isolated to particular soft IP models. From the perspective of soft IP vendors, there is a need for protection of their IP and a need to provide whatever level of separability and observability that is needed by the system vendor. Other IP protection methods such as water marking that allows for the tracing of unauthorized copying or steganography that embeds secret messages in HDL source or object code libraries is not useful for soft IP model intellectual property protection because the objects that need protecting are the conceptual circuit design not the HDL or object library representation. Copying occurs and copy protection is needed downstream when the soft IP model is fabricated as part of an SoC.

VIII. Soft IP Model Conversion and Simulation

In the art, there are currently five basic systems and methods for addressing the SoC conversion simulation problems described above. They are:

1. DISTRIBUTE “AS IS” HDL: In this, the simplest method, the soft IP vendor supplies HDL source to system vendor. This method satisfies neither the system vendor nor the soft IP vendor because there is no well defined interface, there is no way to determine the source of system simulation failure, there is no way to detect subsystem HDL changes, and there is no way to protect intellectual property. The subsystem internal state is available but there is no soft IP vendor control of that observability. Thus, this first method is virtually no method at all.

2. DISTRIBUTE ENCRYPTED HDL: In this method, the soft IP vendor supplies encrypted HDL source to the system vendor. This method is used by the Verilog XL protect/endprotect feature. Although this system and method provides some protection for subsystem IP, it suffers from a number of problems and limitations. First, because the subsystem is still supplied as an HDL source, there is no well defined interface for problem isolation and there is no controlled access to subsystem internal state.

Second, there are problems with IP protection. The encryption key is built into the simulator so that if the encryption scheme is cracked, every protected soft IP model can be decrypted. In fact, in the mid 1990's, the method used in the Verilog XL protect scheme was cracked and posted on the Internet. In general, for any encryption scheme, because the key is embedded in the simulator computer program, the key can be found by disassembly. Also, because the simulator vendors usually have divisions that compete with soft IP providers, the protected HDL is not protected from simulator vendors but rather only from system designers. This method is also simulator specific so that the soft IP vendor must distribute different protected source for each simulator. Finally, because currently only one simulator vendor supports encrypted models, this method is generally not usable.

3. HAND CODE COMPUTER PROGRAM FOLLOWING OMI MODEL STANDARD: In this instance, the IP vendor develops and maintains two versions of the soft IP models. The version that is distributed is a computer program that uses the standardized OMI API to communicate with simulator. The current most commonly used API is the standardized OMI interface standardized as IEEE P1499 standard. This system and method provides a well defined user interface with controlled observability and provides IP protection for the soft IP vendor, but suffers from a number of model development and verification limitations.

First, only a small subset of HDL modeling constructs are provided (see FIG. 1). This limits the soft IP model accuracy especially in the area of timing accuracy. The OMI computer program model is generally limited to subsystem I/O port wave form modeling. However, the most serious problem with this method is that soft IP vendor must develop and maintain two separate and unrelated models. One detailed HDL model and a separate computer program using OMI API. This makes subsystem problem isolation at least twice as difficult and time consuming.

4. SIMULATOR SPECIFIC MODEL COMPILER: Because of advances in computer program linking techniques (see “Background of the Invention” section V above), for simulators that work by compiling HDL source to object code, it is possible to modify the HDL elaboration step to produce linkable object files that are then linked into a final simulation executable program. This modified simulator and elaborator is called a model compiler. It allows soft IP vendors to compile IP models to object files. The soft IP vendor then distributes the one or a plurality of object files to system vendor.

This system and method provides a well-defined user interface with controlled observability. The HDL to object code compiler is instructed to preserve or not preserve I/O port and internal node observability. It also provides IP protection because the produced object file is usually large and because most instruction sequences are similar. It does not protect the IP from the simulator vendor since the simulator vendor is the developer of the program that compiles the soft IP model. However, this system and method is a significant improvement for compiled simulators over methods 1-3 above.

However, this system and method does suffer from two significant problems. First, it only works with simulators that compile code to binary object code. As discussed in section IV above, the model compiler method only works with the type 2. simulation method. This method is not usable with the current most popular Verilog simulator called Verilog XL that is an interpreted simulator. Interpreted simulators such as XL offer significant system debugging advantages. The second problem is that method is not simulator vendor independent. Therefore, the soft IP vendor must distribute different binary object files for every type of simulator. Also, since the method depends on the internal simulator data structures, when major internal changes are made to a given simulator, a new soft IP object file must be created and distributed.

5. PACKAGE SIMULATOR EXECUTABLE WITH EACH MODEL: This is a variant of method 4 above that attempts to overcome the limitations of method 4. In this instance, the soft IP vendor ships both a model from any or all of methods 1-4 above and the particular simulator it is created with. The simulators then communicate by sharing data. Various methods for sharing data are used such as shared files, operating system (OS) shared memory, or OS pipes. The advantage of this method is that it is simulator independent since each soft IP model is distributed with its own simulator, then the system vendor can use any simulator to simulate its part of system model.

However, this method suffers from serious problems. For instance, the system vendor must license and maintain multiple simulators, although all simulators may be sublicensed through soft IP vendors. Also, data transfer and synchronization of the various subsystems becomes difficult and slow. This method is a step backward from modern API based interfaces and inferior to 4 above.

While HDL circuit conversion principles as described above and their potential use in facilitating specialization and creation of soft IP development enterprises are known in the prior art, there is no known method with the advantages of the simulator independent system and method disclosed herein.

Accordingly, it is the object of this invention to provide a system and method that allows or protection of soft IP vendor intellectual property from unrelated third parties, from system vendor licensees, and from simulator vendors. The IP protection is generally superior to any encryption method since the simulation program must store both the key and the decrypted HDL source that can be determined by dis-assembly of the simulation program. IP protection is generally superior to any simulator specific model compiler, because a simulator vendor does not know the details of the converted library object code and because the model compiler vendor is able to shroud and/or obfuscate the object code without increasing simulator development difficulty.

Accordingly, it is also the object of this invention to provide a system and method that simplifies soft IP model distribution by allowing one object file to be linked to any HDL simulator on a give platform architecture type (such as X86 or Sparc).

Accordingly, it is also the object of this invention to provide a system and method that substantially eliminates the need for any open model interface (OMI) standard such as IEEE P14999.

Accordingly, it is also the object of this invention to provide a system and method that is tightly coupled to a simulator's simulation mechanism to allow utilization of simulation advances and efficiency that only a tightly linked API can provide. The system and method described here functions like a biological virus by communicating instructions that are executable by the host simulator using the PLI API.

### SUMMARY OF THE INVENTION

In accordance with one aspect of the present invention, there is provided a method for converting soft IP HDL models into binary object code for use in system simulation. In its preferred embodiment, an HDL soft IP model is converted to a binary object code library by first translating the IP model into C intermediate code and then compiling the C code to a binary object code library. The parallel and time related aspects of simulation are provided by the standardized HDL simulator. The generated intermediate C code and the final binary code call PLI routines for services and to register converted HDL routines that are executed when delays, parallel synchronization events, or changes occur.

The present invention is generally comprised of the following steps:

Extracting net list and program statements from HDL. The net list is generally all procedural blocks and functions, and all declarative gates, delays, and assignments.

Building an internal data structure from the net list. In the preferred embodiment, a graph-based data structure is used for declarative elements and an expression tree-based data structure is used for procedural elements.

Separating (or in other words, classifying or discriminating) each HDL construct in preparation for further processing.

In a preferred embodiment, intermediate form code is generated for each separated HDL construct. Also, HDL constructs such as wired gates or delay lines may imply creation of other HDL constructs. Intermediate code for those implied constructs is also generated.

Generating programming language code from the intermediate code. In a preferred embodiment, C computer language code is generated and written to a file. The C code is grouped into a number of code types including: (1) Evaluation C code to evaluate expressions and assignments; and (2) Scheduling C code to delay events by calling the PLI and interacting with the simulator scheduler.

Compiling generated C code into binary object code that is stored in a dynamic library. In an alternative embodiment, the binary object code is generated directly without first generating the C code and, thereby, eliminating the need for the C compiler.

Distributing converted the converted binary object code files to system developers for use in system simulation. The HDL PLI contains a dynamic object library loading and executing function. The generated C code uses PLI API calls to properly initialize and execute during a system simulation.

It is therefore an object of this invention to provide an HDL simulator independent soft IP model conversion system and method. Other objects, advantages, and features of this invention include, but are not limited to: the protection of soft IP vendor intellectual property, the production of a converted object library trhat runs with substantially any HDL simulator thereby simplifying soft IP model preparation and distribution, and the substantial elimination of the need for open model interface standards such as the IEEE P1499 OMI standard. Other objects, advantages, and features of the present invention will become apparent from the following detailed description when considered in conjunction with the accompanying drawings.

### DESCRIPTION OF THE DRAWINGS

FIG. 1 is a prior art listing showing language constructs in the Verilog HDL. Examples of the various types of Verilog HDL language constructs are shown.

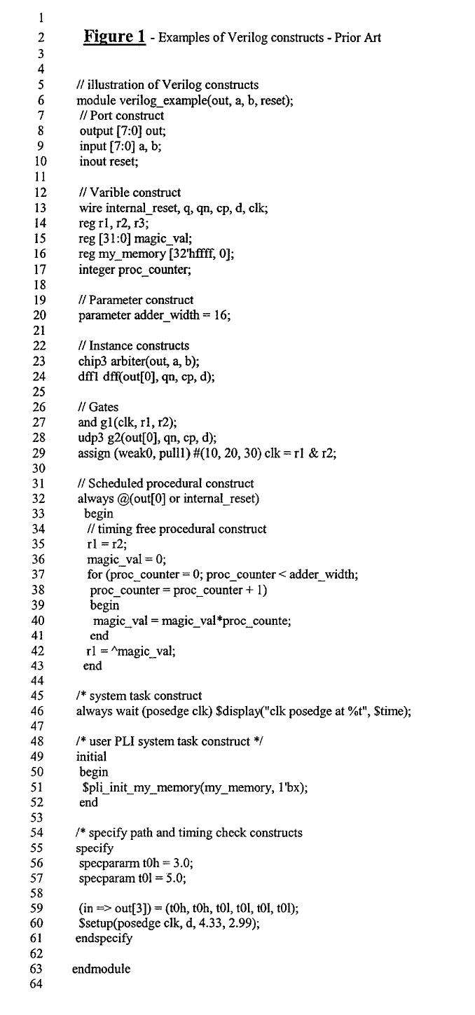

FIG. 2 is an overview flowchart of HDL to object library conversion steps.

FIG. 3 is a flowchart of the steps that are used for system simulation in using the converted object code library created according to FIG. 2.

FIG. 4 is a block diagram of a generic computer system that is used with the present invention.

FIG. 5 is a flowchart of the steps for generating C code for initial/always blocks, which are used to start simulation.

FIG. 6 is a flowchart of the steps for generating C code for timing free procedural constructs.

FIG. 7 is a flowchart of the steps for generating C code for procedural event controls.

FIG. 8 is a flowchart of the steps for generating C code for procedural delay controls.

FIG. 9 is a flowchart of the steps for generating C code for declarative gates.

FIG. 10 is a flowchart of the steps for generating C code for declarative delay paths.

### DETAILED DESCRIPTION OF THE PREFERRED EMBODIMENTS

In accordance with the principles of the present invention, an electronic subsystem (soft IP model) coded in hardware description languages (HDL) is converted into one or a plurality of object libraries that are linked with an HDL simulator to execute system simulation. In the preferred embodiment of the system and method, the programming language interface (PLI) application programming interface (API) is utilized to the maximum extent possible. As discussed below, other possible embodiments that make lesser use of the PLI API are disclosed.

PLI based systems function only through call backs. Any HDL simulator may function as the main program. The simulation system of the present invention operates by registering call back programming language functions that are “called” by a simulator according to the call back reason. Because the HDL simulator already provides much of the needed functionality that is invoked and controlled by the PLI programming language routines, the computer program implementing the system of the present invention need only be of medium complexity and size.

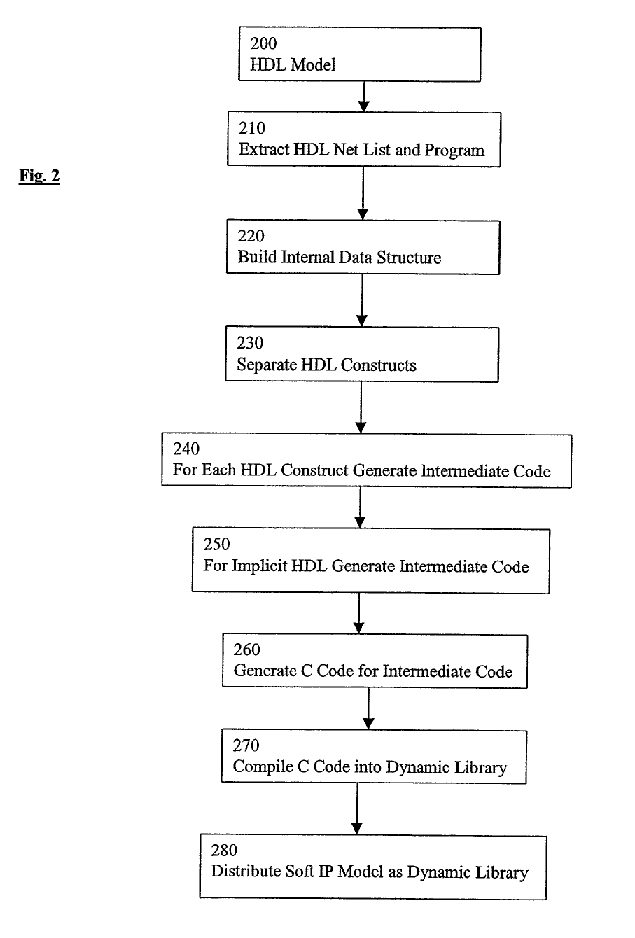

The simulation system and method generally comprises a set of operations performed to convert an HDL soft IP model into a linkable object code library and a set of steps performed during system simulation to link in and execute the converted object code library. Referring to FIG. 2, the one or more HDL files that comprise the soft IP model undergo syntactic analysis by a simulator or other program that provides the source PLI access. The HDL PLI is then used to scan the HDL source and the net list is extracted is shown by block 210. As an alternative embodiment, the HDL is subjected to syntax analysis comprising lexical analysis, first pass syntactic analysis that constructs a symbol table, and second pass syntactic analysis that builds the internal data structure without using source scanning PLI.

During the net list extraction, an internal data structure is constructed, see block 220. For procedural constructs (programming language-like constructs numbered 2, 3, 6, and 7 in “Background of the Invention” section III above), normal compiler internal data structure is constructed. In the preferred embodiment, a statement list and expression trees are constructed. Although many other embodiments are possible such as virtual byte code or four tuples. For declarative constructs (HDL construct types 1, 4, 5, and 9 in “Background of the Invention” section III above) in the preferred embodiment, the net list data structure described in a paper of S. Meyer, “A data structure for circuit net lists”, Proceeding 25th ACM/IEEE Design Automation Conference, 1986, pp. 613-616, which is hereby incorporated by reference, is constructed. This data structure has numerous advantages in computing circuit connectivity and signal net drivers and loads.

Once the internal data structure is built, per block 220, the various HDL constructs stored in the internal data structure are partitioned or separated out by the type of object code that will eventually need to be generated, i.e., the operations of the HDL model are defined from the data structure, see block 230. The separation is roughly by the type of PLI action that will be required: value change monitoring, value setting, expression evaluating, delay scheduling means. In the preferred embodiment, the separation is accomplished by programming language case or switch statements. The bodies of the case statements execute the succeeding steps as defined in FIG. 2. It should be noted that, although in developing the computer program to implement the simulation system and method the operations occur in sequential steps, during program execution the steps are intermixed.

After the separation step, per block 230, each discriminated or classified HDL construct stored in the internal data structure is converted to intermediate code as shown in block 240. In an alternative embodiment, the intermediate code step can be eliminated and the C code generated directly, i.e., remove blocks 240 and 250. In the preferred embodiment, the intermediate code is converted to computer language code in the popular C computer language, however, any other computer language, such as C++, could be used. For concreteness, the discussion in the remainder of the present section uses only conversion into C. The preferred embodiment has the advantage that optimizations and shrouding or obfuscation operations (applied to C code but expressed in compiled output object code) are applied during C code generation from the intermediate code more easily.

HDLs commonly have constructs that require simulation by the PLI model object code although there is no explicit construct in HDL source, i.e., they are implicit. The most common implicit constructs are logic gates implemented by wire connections (called “wired or” and “wired and”), delay lines (delay logic gates) implemented by trireg wire type in Verilog and continuous assignments implied by instance input and output ports. As shown in block 250, the internal data structures built in block 220, are scanned to locate implicit constructs. The implicit constructs are then analyzed and intermediate code is generated.

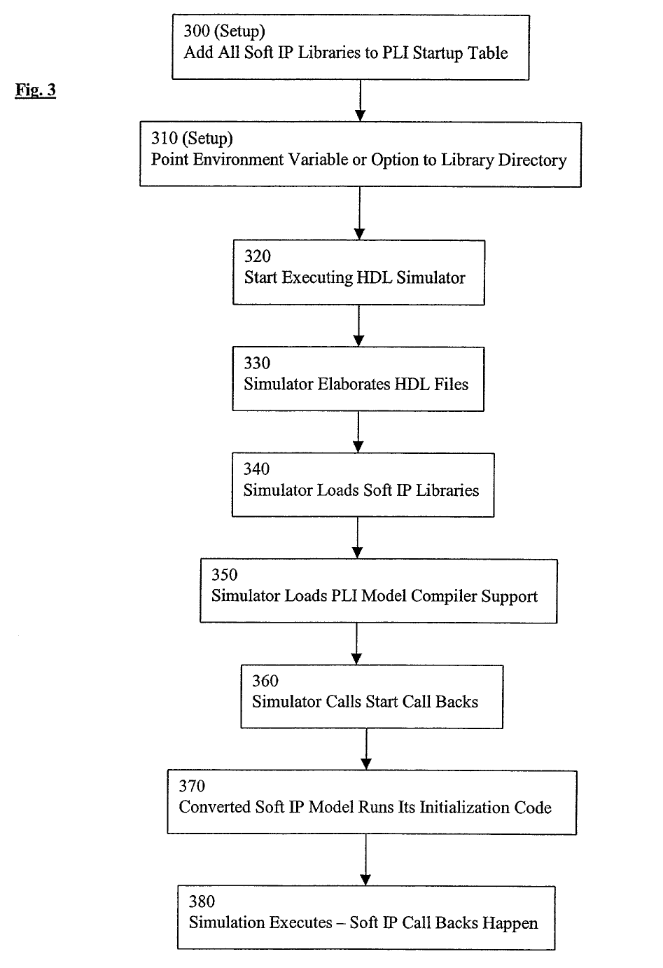

Next as shown by block 260, C code is generated (written to a.c file). Because HDL PLIs work by first registering call backs of programming language routines and then executing routines when call back reasons occur, the C code generation phase outputs initialization code that is run during system simulation setup (see FIG. 3) is written to one file and the call back action code (code that “simulates”) is written into another file. In an alternative embodiment, all code may go into one file or, in still another embodiment, each separate call back routine may be written into a separate file. It should be noted that, although separate routines can be generated for every call back, in the preferred embodiment, a small number of generalized call back routines are generated and jump tables or switch statements are used. This defers processing to later fixed time points and groups all related call backs and related objects so that all processing can be done in one routine with only one call back. This significantly improves the soft IP model simulation speed.

Once the C code has been generated, per block 260, a programming language compiler is used to compile the generated C code into one or more dynamic object code libraries, see block 270. In an alternative embodiment, assembly or binary library object code is generated directly. This reduces model compilation time at the cost of increased model compiler program complexity. Once compiled, the dynamic library of the soft IP model may be distributed for use in system simulations, see block 280.

In accordance with the principles of the present invention, use of the compiled soft IP model object library in system simulation is described. Reference is made to FIG. 3 for those steps needed to setup and execute a system simulation. The setup steps are performed once. From then on, system simulations are just executed unless new or changed soft IP models need to be added to system simulation in which case the setup steps shown in FIG. 3 need to be repeated. Before the simulator is run, the first setup step as shown in block 300 is to add soft IP models to PLI startup tables. During model compilation the various module and subsystem type names are output into the dynamic library for each compiled soft IP subsystem. These names must be defined in the simulator PLI startup tables so that they are called during simulator initialization where they register the action call backs that perform the simulation. Every different HDL simulator uses slightly different startup tables. For the Verilog HDL, the startup table and linking requirements for a number of different simulators are described in a book of S. Sutherland, “The Verilog PLI Handbook”, Kluwer Academic Publishers, Boston, 1999, which is hereby incorporated by reference.

As shown in block 310, the next setup step requires the setting of the operating system environment variables or simulator options so that when the HDL simulator starts up, the compiled soft IP model dynamic libraries can be located. Next as shown in block 320, the simulator program is started. As shown in block 330, the simulator reads and elaborates all of the system HDL files. After elaboration, the simulator soft IP libraries are loaded (linked with simulator according to one of the methods described in the “Background of the Invention” section V above), see block 340. Next, as shown in block 350, the simulator loads the support libraries needed by the PLI model compiler. The main purpose of the model compiler support library is to provide interfaces to the system PLI constructs (HDL construct type 7 above) such as displaying output.

In FIG. 3 blocks 350 to 380, the simulator calls the object code library routines produced by the PLI model compiler simulation system of the present invention, i.e., the simulator loads the PLI model compiler support, per block 350, the simulator calls the start call backs, per block 360, the simulator runs the soft IP model initialization code, per block 370, and the simulation executes, per block 380. These steps are executed by the simulator by making PLI calls and registering call backs resulting in soft IP model simulation.

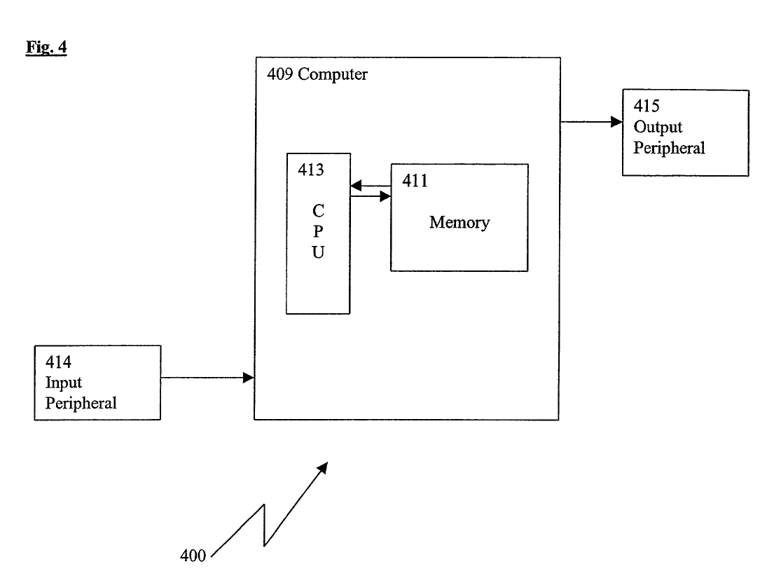

FIG. 4 provides an overview block diagram of the computer system 400 that may be used to implement the simulation system and method described herein. As shown computer system 400 generally comprise a computer program residing in the memory 411 of a computer 409, e.g., a computer having a central processing unit 413, that runs the conversion program and simulator program of the present invention. Computer system 400 preferably includes input peripherals 414, e.g., disk drives, keyboards, etc., as well as output peripherals 415, e.g., CRT, data storage devices, disk drives, etc.

The simulation system of the present invention will now be shown in more detail by describing the details of the programming language code generation phase, i.e., FIG. 2, block 260, for the current most popular Verilog HDL using the popular C programming language. In general, the C code is grouped into a number of code types. For example, initialization C code that is run when system simulation begins to register PLI change call back events, evaluation C code to evaluate expressions and assignments, and scheduling C code to delay events by calling the PLI and interacting with the simulator scheduling system.

Because all HDLs model hardware, C code generation for any other HDL is substantially the same. The HDL analysis phase uses compiler construction methods known in the art. The C code generation phase differs from compiled HDL simulation systems, such as the one described in U.S. Pat. No. 5,437,037 (which is hereby incorporated by reference), because in the present invention the PLI provides simulation services so that C language calls to invoke PLI services simply generate PLI calls instead of needing to implement simulation operations.

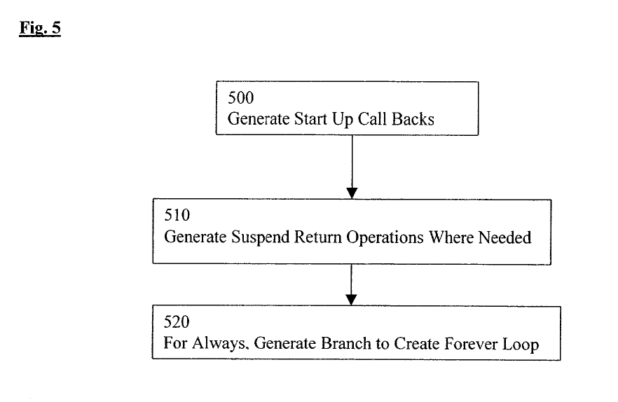

FIG. 5 shows the C code generation steps for initial/always blocks. Verilog simulation begins by executing all initial and always blocks in parallel. Therefore, as shown in block 500, C code must be generated to call the C function or functions that contain the C code that simulates each initial and always block. In the preferred embodiment, all initial/always block C code for a given Verilog module is placed in one C function. Each initial/always block startup call passes a label indicating which of the code sections in the C function needs to be executed. The label is either used to index a jump table or as a switch statement selector. Per block 510, a return to simulator return statement is placed at the end of each initial block. Per block 520, for always blocks at the end of the C code that simulates the always block's procedural content, a goto statement back to the beginning of the always block is emitted. Alternatively, each always block implementing C code is enclosed in a forever loop.

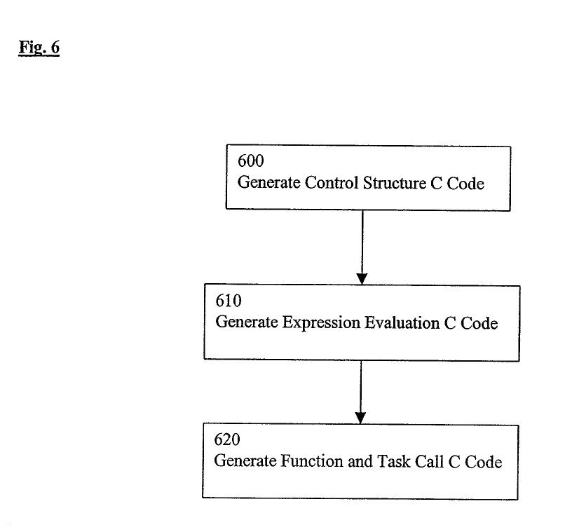

FIG. 6 shows C code generation steps for the timing free procedural constructs. This is the easiest C code to generate since it does not involve parallelism. Because Verilog construct types were separated out (see FIG. 2 block 230 above), the control structure constructs (such as for loops and wait loops) are located and corresponding C language constructs such as for loops and goto statements are written into the output C file per block 600. In the preferred embodiment, C loops are used because optimizing C compilers produces more efficient code. In an alternative embodiment, all Verilog loops are decomposed into C goto and if statements. Next, per block 610, C code to compute all expressions and assignments in procedural code are generated. C code generation is almost identical to normal programming language compiler code generation except expressions and assignments are more complex in Verilog because Verilog has 4 values for each bit (0, 1, X, and Z) and because Verilog vectors are allowed that are as wide as 1 million bits. Finally, per block 620, C code to invoke functions and tasks is generated. Function and task input arguments and return values must be pushed onto a call stack before C code call is generated and popped at end of C code to implement function or task calling and returning. Because tasks can be suspended, instead of a direct call to invoke task, C code to schedule a call back must be registered (set up) and then the C statement to return to HDL simulator is generated.

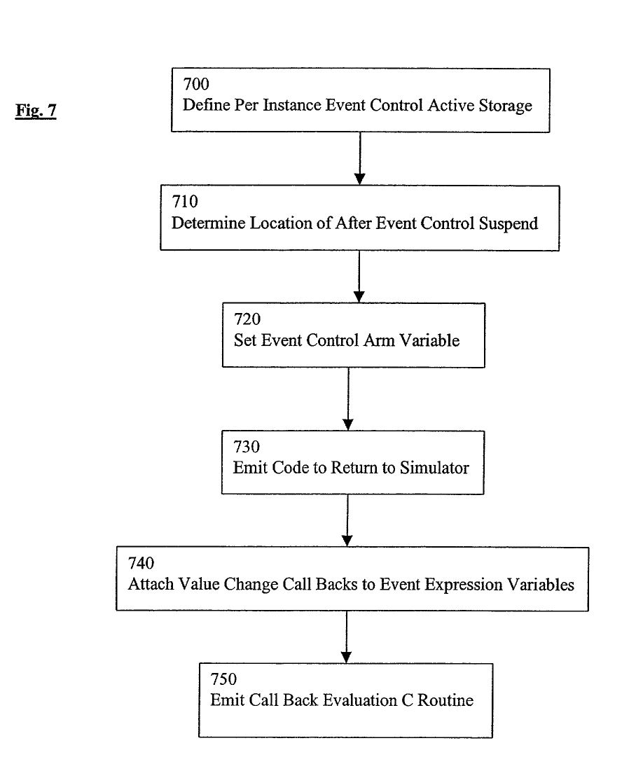

FIG. 7 shows C code generation steps for procedural event controls. Procedural event controls in Verilog stop execution of a particular parallel initial/always block until the triggered event occurs. Per block 700, storage must be allocated to record for every event control in every instance whether or not an initial or always block is currently suspended waiting for the event to occur. Per block 710, the direction is provided to resume location after event control is determined. A C label must be generated at that point where procedural code for Verilog statement after event control starts. Event control resume C code call back uses the label to jump to after the event control resume C statement during simulation. Per block 720, C code is generated just before the event control statement C code to set to true the storage allocated in block 700 for the given event control. Next per block 730, code to return to the simulator is generated. Per block 740, in simulation startup, C function code to attach value change call backs to every variable used in event control expression is generated. Per block 750, at the start of the code after the event control, code to evaluate the event control expression is generated. There are actually two cases for block 750. For simple event control expressions called change operators, the call back itself causes execution to continue after event control. For complex event control expressions such as “wait (c1k=0 && clear=0)”, C code must be generated to evaluate expression and if false, re-arm the event control and return to the simulator instead of continuing execution as is always the case in simple event controls.

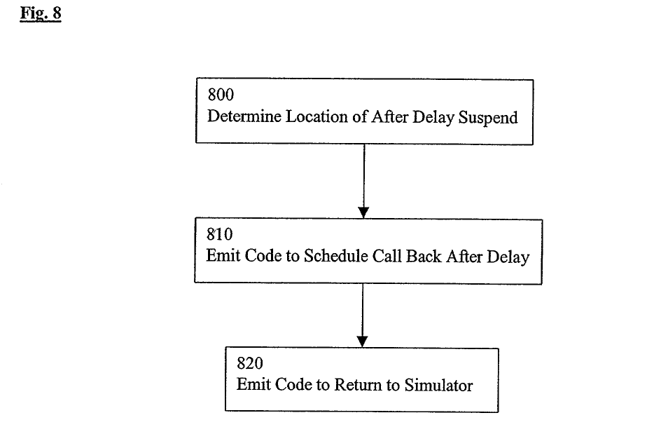

FIG. 8 shows C code generation steps for procedural delay controls. Procedural delay controls in Verilog stop execution until time has elapsed. Per block 800, first the location after delay is located to allow a label to be defined. Then per blocks 810 and 820, C code to schedule a delay reason call back and return to the simulator is generated.

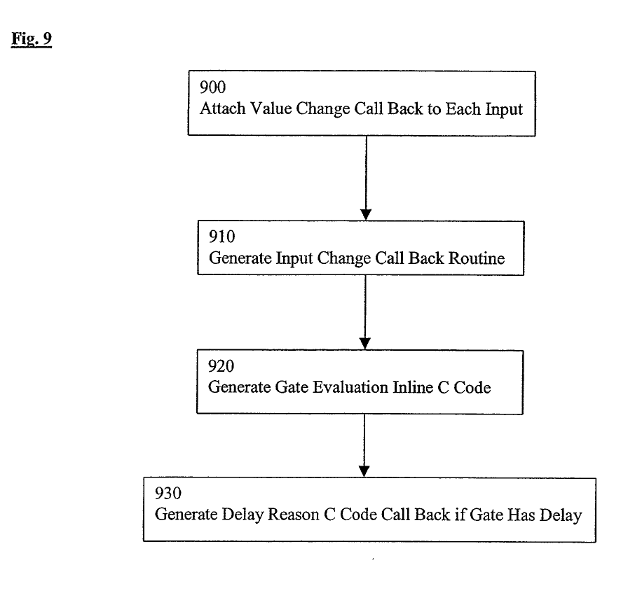

FIG. 9 shows C code generation steps for declarative gates. Per block 900 in simulation startup C code, calls to register (attach) value change call backs to gate input are generated. Per block 920, in a routine implementing all declarative constructs in a module, a routine to implement gate functionality is generated. It is called when any gate input changes per block 900. The body of the gate evaluation routine evaluates the gate and checks to see if a new value is different. If the value changed and there is no delay, vpi_put_value PLI routine is called to change the value of gate output. If the gate has delay, per block 930, a delay reason call back is registered and when the delay has elapsed, the call back routine stores the value into the gate output. The evaluation routine per block 910 uses the vpi_get_value PLI routine to access the current value of other inputs that did not change. The gate evaluation code is a simple C expression evaluation code. For example, the code to evaluate a 2 input “and” gate (assuming all values have a and b parts as defined in Verilog LRM) in the preferred algebraic formula evaluation method is:

/* case 1: neither input x/z */
if (!inlb & !in2b)

{
/* if either input 0, value 0 else value 1 */
if (in1a == 0 || in2a == 0) outa = 0; else outa = 1;
outb = 0;
}

/* case 2: if either input non x/z value 0, then output 0 else x */
else

{
if (((in1a | in1b) == 0) || ((in2a | in2b) == 0)) outa = outb = 0;
else outa = outb = 1;
}

In an alternative embodiment, gate evaluation is accomplished by table look up instead of through the evaluation of logic equations.

The implicit operations, such as gates required by “wired or” signal net connections and delay lines, have C code generated during this phase. The implicit operations were identified, per block 250 of FIG. 2, and saved. C code is then generated during this declarative gate C code generation phase.

HDLs often contain user coded primitive gates (called UDPs in Verilog) that are defined with user specified tables. Here, in all embodiments, the generated C code executes the one or more table look up operations defined by the standard for a given HDL. For Verilog HDL sequential primitive UDPs, evaluation may require multiple table look up operations.

In the preferred embodiment, there are a number of optimizations that reduce the number of call backs and returns back to the simulator. Since a number of gates may need to have their output value stored at the same time, a list of gates is kept and only one call back is registered in which all gate output values are stored. During C code generation, the need for a change call back is stored in the net list data structure and whenever a new call back is needed a check is made to see if there is already a call back generated. This same optimization is used for grouping gate inputs changes and event and delay controls changes and delay call backs as well.

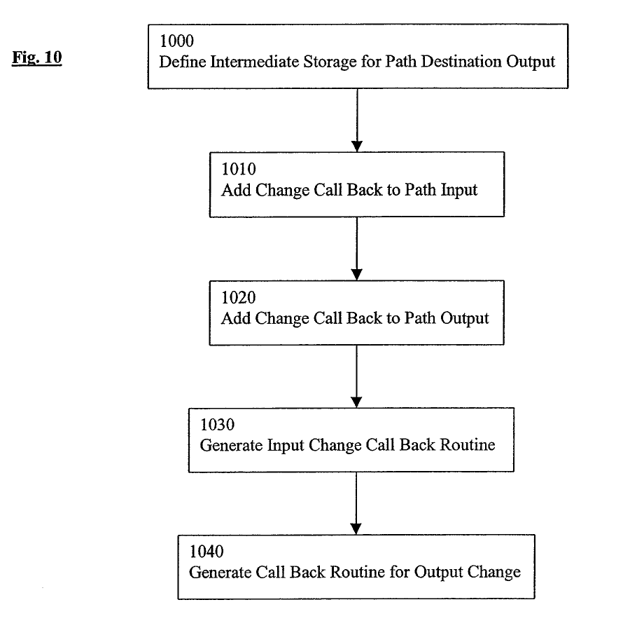

FIG. 10 shows the C code generation steps for declarative path delays. Path delays work by delaying the actual output change until the path delay has elapsed. Because of the delayed change, per block 1000, extra C code per instance storage must be allocated to store pending but not yet changed path destination output value. Per block 1010, a change call back is added to path input (called path source). As above, related changes are grouped into one call back. Per block 1020, a change call back is also added to path output. The change call back is used to intercept and delay actual path output put value operation. Per block 1030, the C code is generated for an input change call back routine. The C code schedules the delay call back that is later used to see if the output change call back routine time has matured per block 1040 so that the value can be assigned to path output port. In the preferred embodiment, if the change needs to be delayed more after the logic value changes, the same output change call back routine is called with different user data flag.

The only remaining C code generation involves developing the library of miscellaneous, system, and simulator service operations that are invoked by the generated C code in the various figures that were described in detail above. C code to control user access and the visibility of internal HDL variables is also generated during this phase. In addition, the main HDL constructs that need support library calls, e.g., system task and function constructs (item 7 in “Background of the Invention” section III above), have support library calls generated. Miscellaneous HDL functions are such tasks as starting and stopping simulation, writing results to output, monitoring and strobing net changes and debugging and viewing signal waveforms. For each such function defined in the HDL, one or all of the following three listed methods is used: (1) use a built-in predefined PLI function corresponding to a given miscellaneous function to implement the given task; (2) generate additional HDL source that only contains system tasks and functions. The generated object code file then contains PLI operations to execute the given source statement; or (3) provide a library that mimics (simulates using object file code) miscellaneous functions for a given HDL.

An additional HDL generation step may be added to FIG. 2, which is not strictly required by the simulation system and method of the present invention, but is useful in making system HDL source files that are easier to use with other Verilog tools and easier to understand. The additional step is to generate HDL (not C) source files defining input port order, size, and type for all modules in the converted soft IP model. Other HDL processing tools can then analyze the system model.

The present invention may be embodied in other specific forms without departing from the spirit of the essential attributes thereof; therefore, the illustrated embodiments should be considered in all respects as illustrative and not restrictive, reference being made to the appended claims rather than to the foregoing description to indicate the scope of the invention.

What is claimed:

1. A system for simulating an electronic circuit model that has been coded into a hardware description language (HDL), comprising:
a processor having memory for storing a program that is capable of being executed by said processor said program directing the operation of said processor to:
convert the HDL coded electronic circuit model to binary object code; and
simulate the electronic circuit by utilizing said binary object code.

2. The system of claim 1, wherein said program directs said processor to convert the HDL coded electronic circuit model to binary object code by directing said processor to translate the HDL coded electronic circuit model into an intermediate program language code and to compile said intermediate program language code to said binary object code.

3. The system of claim 2, wherein said intermediate program language code is a C program language code.

4. The system of claim 3, wherein said C program language code is grouped into code types selected from a group consisting of: evaluation C code and scheduling C code.

5. The system of claim 1, wherein said binary object code performs operations that are selected from a group consisting of: initial/always block operations, timing-free procedural operations, task procedural operations, function procedural operations, event control operations, delay control operations, scheduled procedural operations, declarative gate operations, continuous assignment operations, user-defined primitive operations, implicit wired operations, delay path operations, system task operations, and system service operations.

6. The system of claim 1, wherein said program directs said processor to simulate the electronic circuit by utilizing said object code to make calls to a programming language interface (PLI).

7. The system of claim 1, wherein said binary object code is utilizable by substantially all types of simulators.

8. A method for simulating an electronic circuit model that has been coded into a hardware description language (HDL), comprising:
reading the HDL coded electronic circuit model;
converting the HDL coded electronic circuit model into a linkable simulation program; and
simulating the operation of the electronic circuit by utilizing said linkable simulation program.

9. The method of claim 8, wherein said step of converting comprises the steps of translating the HDL coded electronic circuit model into an intermediate program language code and compiling the intermediate program language code to said linkable simulation program.

10. The method of claim 9, wherein said intermediate program language code is a C program language code.

11. The method of claim 10, wherein said step of converting further comprises the step of group said C program language code into types selected from a group consisting of: evaluation C code and scheduling C code.

12. The method of claim 8, wherein said linkable simulation program performs operations that are selected from a group consisting of: initial/always block operations, timing-free procedural operations, task procedural operations, function procedural operations, event control operations, delay control operations, scheduled procedural operations, declarative gate operations, continuous assignment operations, user-defined primitive operations, implicit wired operations, delay path operations, system task operations, and system service operations.

13. The method of claim 8, wherein said step of simulating comprises making calls to a programming language interface (PLI).

14. The method of claim 8, wherein said linkable simulation program is utilizable by substantially all types of simulators.

15. A system for simulating an electronic circuit model that has been coded into a hardware description language (HDL), comprising:
processing means for executing a program, wherein said program includes a conversion means for converting the HDL coded electronic circuit model into a simulator-operable program and a simulation means for simulating the HDL coded circuit model by utilizing said simulator-operable program to make calls to a programming language interface (PLI).

16. The system of clam 15, wherein said simulator-operable program comprises binary object code.

17. The system of claim 15, wherein said conversion means includes means for translating the HDL coded electronic circuit model into an intermediate program language code and means for compiling said intermediate program language code to said simulator-operable program.

18. The system of claim 17, wherein said intermediate program language code is a C program language code.

19. The system of claim 18, wherein said C program language code is grouped into code types selected from a group consisting of: evaluation C code and scheduling C code.

20. The system of claim 15, wherein said simulator-operable program performs operations that are selected from a group consisting of: initial/always block operations, timing-free procedural operations, task procedural operations, function procedural operations, event control operations, delay control operations, scheduled procedural operations, declarative gate operations, continuous assignment operations, user-defined primitive operations, implicit wired operations, delay path operations, system task operations, and system service operations.

21. The system of claim 15, wherein said simulator-operable program is utilizable by substantially all types of simulators.
